(19) United States
(12) Patent Application Publication
(10) Pub. No.: US 2026/0062302 A1
(43) Pub. Date: Mar. 5, 2026

(54) METHODS AND SYSTEMS FOR GENERATING CARBON DISULFIDE

(71) Applicant: CHEVRON U.S.A. INC., San Ramon, CA (US)

(72) Inventors: Fathollah GOZALPOUR, San Ramon, CA (US); Jennifer Michelle Cain Meyer, San Ramon, CA (US); Piyush Balkrishna Shah, San Ramon, CA (US); Yousef Ghomian, San Ramon, CA (US); Jitendra Kikani, San Ramon, CA (US)

(21) Appl. No.: 18/825,779

(22) Filed: Sep. 5, 2024

(51) Int. Cl. C01B 32/75; C01B 3/50

(52) U.S. Cl. CPC C01B 32/75; C01B 3/50

(57) ABSTRACT

The present application pertains to a method of making carbon disulfide. The method comprises reacting methane and sulfur under conditions sufficient to produce carbon disulfide, hydrogen disulfide, and heat. At least a portion of the produced hydrogen disulfide is reacted with methane under conditions sufficient to produce a mixture comprising carbon disulfide and hydrogen. Advantageously, at least a portion of the heat from reacting methane and sulfur is employed in the reacting of at least a portion of the produced hydrogen disulfide with methane.

### FIELD OF THE DISCLOSURE

The present disclosure relates to methods and systems for generating carbon disulfide (CS₂).

### BACKGROUND AND SUMMARY

Carbon disulfide is useful in a variety of industries. For example, it is useful in the textile industry for the manufacture of viscose rayon and cellophane film, is used as a solvent, and has potential applications in the oil and gas industry for enhanced oil recovery. An existing commercial process uses molten sulfur and natural gas to make carbon disulfide with hydrogen disulfide as a by-product. A second process for making carbon disulfide that has been described in the literature reacts hydrogen disulfide with natural gas to make carbon disulfide and hydrogen. This process is attractive since it produces hydrogen as a by-product but has yet to be deployed at a commercial or industrial scale.

There are several technical challenges associated with the production of carbon disulfide and hydrogen from hydrogen disulfide and natural gas. It requires a significant amount of energy to reach the required high reactor temperatures. The source of hydrogen disulfide feed is also not readily available at an industrial scale, and any oxygen containing compounds like carbon dioxide may also be harmful to and/or limit the useful life of catalysts employed. Thus, what is needed are improved systems and methods for making carbon disulfide that are efficient and effective that overcome the high energy requirements and difficulty in sourcing nearly pure hydrogen disulfide at an industrial scale. If such processes could be located onsite at an oil and gas facility in need of carbon disulfide for enhanced oil recovery, then that would be even further desirable.

Advantageously, the current inventions solve many of the aforementioned issues with prior processes and systems. In one embodiment the present application pertains to a method of making carbon disulfide. The method comprises reacting methane and sulfur under conditions sufficient to produce carbon disulfide, hydrogen disulfide, and heat. At least a portion of the produced hydrogen disulfide is reacted with methane under conditions sufficient to produce a mixture comprising carbon disulfide and hydrogen. Advantageously, at least a portion of the heat from reacting methane and sulfur is employed in the reacting of the produced hydrogen disulfide with methane.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawing.

FIG. 1 shows a representative two stage reactor scheme.

### DETAILED DESCRIPTION

This application pertains to a process for making CS₂ wherein a first stage involves reacting methane and sulfur under conditions sufficient to produce carbon disulfide, hydrogen disulfide, and heat as follows: CH₄+4S→CS₂+2 H₂S+heat. A second stage of the process involves reacting most of the produced hydrogen disulfide from the first stage with methane under conditions sufficient to produce a mixture comprising carbon disulfide and hydrogen as follows: CH₄+2H₂S→CS₂+4H₂. Most of the heat from reacting methane and sulfur in the first stage may be employed in the second stage of reacting produced hydrogen disulfide with methane.

### First Stage

Methane and sulfur are reacted under conditions sufficient to produce carbon disulfide, hydrogen disulfide, and heat in the first stage. The equipment employed may vary depending upon the reaction conditions and desired results. On the other hand, the reaction conditions may vary depending upon the equipment employed and desired results. In some embodiments a waste heat boiler may be employed with, for example, an H₂S blower, and various compressors.

The temperature, pressure, and catalysts, if any, employed during the reacting of methane and sulfur is not particularly critical so long as the desired sulfur conversion is achieved with high product selectivity. Similarly, useful temperatures and pressures may vary depending upon the equipment and the catalysts employed. Generally, the reactor pressure in the first stage is optimized to improve heat and process integration. at least about 0.5, or at least about 0.75, or at least about 1.2 barg up to about 3.5, or up to about 3.0, or up to about 2.4 barg. Reactor temperatures, of course, may vary depending upon pressure and other factors. Generally, useful reactor temperatures may be at least about 400° C., or at least about 500° C., or at least about 600° C. up to about 900° C., or up to about 800° C., or up to about 700° C.

If desired, one may recycle at least a portion of any unreacted sulfur in the reacting of methane and sulfur. For example, the reactor may be designed to continuously recycle unconverted sulfur while achieving desired reactor operating conditions.

The heat generated in the stage 1 reaction may be used in-stage 2, or subsequently in any desired manner whether that be directly or indirectly. In some embodiments, the heat generated may comprise steam which, if desired, may be converted to generate electricity. Any electricity generated may be used in the process, e.g., in the reacting of the at least the portion of the produced hydrogen disulfide with methane in the second stage.

### Second Stage

Methane and hydrogen disulfide from the first stage are reacted under conditions sufficient to produce carbon disulfide and hydrogen in the second stage. The equipment employed may vary depending upon the reaction conditions and desired results. On the other hand, the reaction conditions may vary depending upon the equipment employed and desired results. In some embodiments a furnace may be employed with, for example, various separators or other equipment.

The temperature, pressure, and optional catalysts employed during the reacting of methane and hydrogen disulfide is not particularly critical so long as the desired products are formed. Similarly, useful temperatures and pressures may vary depending upon the equipment and the catalysts, if any, employed. Generally, the reactor pressure in the second stage is at least about 0.5, or at least about 0.6, or at least about 1.2 barg up to about 4.5, or up to about 4.0, or up to about 2.8 barg. Reactor temperatures, of course, may vary depending upon pressure and other factors. Generally, useful reactor temperatures may be at least about 600° C., or at least about 700° C., or at least about 800° C. up to about 1200° C., or up to about 1100° C., or up to about 1000° C.

The mixture formed may be cooled to facilitate separation. The hydrogen, if separated as described below, may additionally or alternatively be used as fuel in the reacting of at least a portion of the produced hydrogen disulfide with methane in this stage 2.

### Optional Steps

If desired, additional reagents, solvents, or catalysts may be employed as part of the first stage, the second stage, and/or both. Optional steps may also be employed after the first stage, second stage, or both. For example, carbon disulfide and hydrogen disulfide may be separated by any convenient method as part of or in addition to the first stage. Similarly, carbon disulfide and hydrogen in the second stage mixture may be separated by any convenient method as part of or in addition to the second stage.

The aforementioned separating may be accomplished at any convenient conditions which may vary depending upon, for example, the equipment employed, the concentrations, the temperatures, and/or other conditions of the products of the first and/or second stage. For example, the carbon disulfide and hydrogen disulfide produced in the first stage may be separated by cooling the reactor effluent with refrigeration followed by separation. If desired, at least a portion up to all of the steam generated in the first stage may be employed to drive a refrigeration compressor used in the separating.

Similarly, if desired one may separate carbon disulfide and hydrogen produced in the second stage mixture. This may be accomplished by cooling followed by separation using, for example, a refrigeration compressor. The temperatures and pressures employed in the separating may vary but in some embodiments the temperature may be from about −50° C. to about −10° C. A suitable pressure may be from about 0.9 barg to about 1.9 barg. Once separated, either or both products may be compressed for storage and transportation or alternatively employed in a suitable process. For example, separated hydrogen may be blended into a fuel gas while separated carbon disulfide may be employed in an enhanced oil recovery process. Separated hydrogen may additionally or alternatively be used as fuel in the reacting of at least a portion of the produced hydrogen disulfide with methane in stage 2.

### EXAMPLE

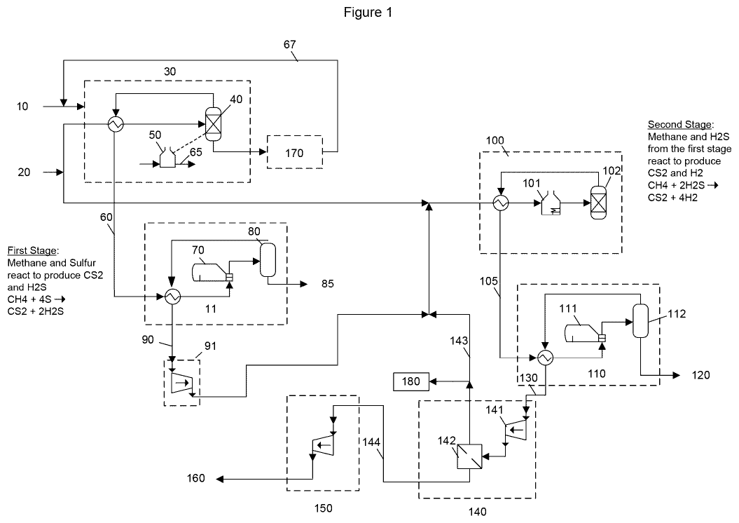

FIG. 1 shows an exemplary process of two-stage carbon disulfide generation. As shown in FIG. 1 molten sulfur 10 and methane gas 20 enter reactor zone 30 comprising a reactor 40 and a waste heat boiler 50. The reaction in reactor 40 produces a mixture 60 comprising CS₂ and H₂S The steam 65 may be exported to use in Stage 2 while any unreacted sulfur 67 exits reactor 40 and, if required, is recycled in 170, mixed with molten sulfur 10 and input to the reactor zone 30. The mixture 60 comprising CS₂ and H₂S is then transferred to CS₂ separation zone 11, which may include a refrigerator 70 and a separator 80. The mixture 60 is cooled in refrigerator 70 and separated in separator 80 to form stream 85 comprising separated CS₂, which may be stored or transferred to applicable use, and stream 90 comprising separated H₂S. Stream 90 comprising separated H₂S may be compressed in H₂S blower/compressor 91 and is then mixed with methane gas (20) and unconverted reactants (143) and sent to reactor zone 100 where it is heated (by heater 101). H₂S reacts with methane (in reactor 102) to produce a mixture 105 of CS₂ and H₂. The mixture 105 of CS₂ and H₂ is then transferred to CS₂ separation zone 110, which includes a refrigerator 111 and a separator 112. The mixture 105 is cooled in refrigerator 111 and separated in separator 112 to form stream 120 comprising separated CS₂ and remainder stream 130. The separated CS₂ stream 120 is sent to storage or other use while the remainder stream 130 enters H₂ separation zone 140. The H₂ separation zone 140 includes a compressor 141 and a separator 142, e.g., a membrane separator, for separating H₂ 144 from any unreacted CH₄ 143 in the remainder stream 130. The unreacted CH₄ 143 may be recycled, mixed with the H₂S stream 90/methane gas 20 and input to the reactor zone 100. A purge stream may exit stream 143 and be sent to incinerator 180 as needed. The separated H₂ 144 is then compressed in H₂ compressor 150 and then stream 160 comprising compressed hydrogen may be stored or employed for use in the instant process or another suitable use.

### SPECIFIC EMBODIMENTS

Additional specific embodiments are described in the numbered embodiments below.
1. A method for making carbon disulfide comprising:
reacting methane and sulfur under conditions sufficient to produce carbon disulfide, hydrogen disulfide, and heat; and
reacting at least a portion of the produced hydrogen disulfide with methane under conditions sufficient to produce a mixture comprising carbon disulfide and hydrogen;
wherein at least a portion of the heat from reacting methane and sulfur is employed in the reacting of the at least the portion of the produced hydrogen disulfide with methane.
2. The method of embodiment 1 which further comprises separating carbon disulfide and hydrogen disulfide.
3. The method of embodiment 1 which further comprises separating carbon disulfide from hydrogen sulfide and hydrogen in the mixture.
4. The method of embodiment 3 which further comprises separating hydrogen from hydrogen sulfide.
5. The method of embodiment 4 which further comprises compressing the separated hydrogen.
6. The method of embodiment 4 which further comprises blending said separated hydrogen into fuel gas.
7. The method of embodiment 2 which further comprises employing at least a portion of said separated carbon disulfide in another process.
8. The method of embodiment 3 which further comprises employing at least a portion of said separated carbon disulfide in another process.
9. The method of embodiment 4 which further comprises employing at least a portion of said separated hydrogen as fuel in the reacting at least a portion of the produced hydrogen disulfide with methane.
10. The method of embodiment 1 further comprising recycling at least a portion of any unreacted sulfur in the reacting of methane and sulfur.
11. The method of embodiment 1 wherein the heat comprises steam.
12. The method of embodiment 11 which further comprises converting at least a portion of the steam to generate electricity.
13. The method of embodiment 12 wherein at least a portion of the generated electricity is employed in the reacting of the at least the portion of the produced hydrogen disulfide with methane.
14. The method of embodiment 1 which further comprises cooling the mixture comprising carbon disulfide and hydrogen.
15. The method of embodiment 1 wherein the reacting of methane and sulfur is conducted a reactor pressure of from about 0.5 barg to about 3.5 barg.
16. The method of embodiment 1 wherein the reacting of methane and sulfur is conducted a reactor pressure of from about 1.2 barg to about 2.4 barg.
17. The method of embodiment 1 wherein the reacting of methane and sulfur is conducted at a reactor temperature of from about 500° C. to about 800° C.
18. The method of embodiment 1 wherein the reacting of methane and sulfur is conducted at a reactor temperature of from about 600° C. to about 700° C.
19. The method of embodiment 1 wherein the reacting of the produced hydrogen disulfide with methane is conducted at a reactor pressure of from about 0.6 barg to about 4.0 barg.
20. The method of embodiment 1 wherein the reacting of the produced hydrogen disulfide with methane is conducted at a reactor pressure of from about 1.2 barg to about 2.8 barg.
21. The method of embodiment 1 wherein the reacting of the produced hydrogen disulfide with methane is conducted at a reactor temperature of from about 700° C. to about 1100° C.
22. The method of embodiment 1 wherein the reacting of the produced hydrogen disulfide with methane is conducted at a reactor temperature of from about 800° C. to about 1000° C.
23. The method of embodiment 1 which further comprises separating carbon disulfide and hydrogen in the mixture at a temperature of from about −50° C. to about −10° C. and a pressure of from about 0.9 barg to about 1.9 barg.
24. A system comprising:
a first reactor configured to react methane and sulfur under conditions sufficient to produce carbon disulfide, hydrogen disulfide, and heat in an exothermic reaction; and
a second reactor operatively coupled to the first reactor, wherein the second reactor is configured to react at least a portion of the produced hydrogen disulfide from the first reactor with methane under conditions sufficient to produce a mixture comprising carbon disulfide and hydrogen in an endothermic reaction;
wherein the first reactor and second reactor are heat integrated such that at least a portion of the heat generated in the exothermic reaction between methane and sulfur in the first reactor is employed to propagate the endothermic reaction between the produced hydrogen disulfide and methane in the second reactor.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. A method for making carbon disulfide comprising:
reacting methane and sulfur under conditions sufficient to produce carbon disulfide, hydrogen disulfide, and heat; and
reacting at least a portion of the produced hydrogen disulfide with methane under conditions sufficient to produce a mixture comprising carbon disulfide and hydrogen;
wherein at least a portion of the heat from reacting methane and sulfur is employed in the reacting of the at least the portion of the produced hydrogen disulfide with methane.

2. The method of claim 1 which further comprises separating carbon disulfide and hydrogen disulfide.

3. The method of claim 1 which further comprises separating carbon disulfide from hydrogen sulfide and hydrogen in the mixture.

4. The method of claim 3 which further comprises separating hydrogen from hydrogen sulfide.

5. The method of claim 4 which further comprises compressing the separated hydrogen.

6. The method of claim 4 which further comprises blending said separated hydrogen into fuel gas.

7. The method of claim 2 which further comprises employing at least a portion of said separated carbon disulfide in another process.

8. The method of claim 3 which further comprises employing at least a portion of said separated carbon disulfide in another process.

9. The method of claim 4 which further comprises employing at least a portion of said separated hydrogen as fuel in the reacting at least a portion of the produced hydrogen disulfide with methane.

10. The method of claim 1 further comprising recycling at least a portion of any unreacted sulfur in the reacting of methane and sulfur.

11. The method of claim 1 wherein the heat comprises steam.

12. The method of claim 11 which further comprises converting at least a portion of the steam to generate electricity.

13. The method of claim 12 wherein at least a portion of the generated electricity is employed in the reacting of the at least the portion of the produced hydrogen disulfide with methane.

14. The method of claim 1 which further comprises cooling the mixture comprising carbon disulfide and hydrogen.

15. The method of claim 1 wherein the reacting of methane and sulfur is conducted a reactor pressure of from about 0.5 barg to about 3.5 barg.

16. The method of claim 1 wherein the reacting of methane and sulfur is conducted a reactor pressure of from about 1.2 barg to about 2.4 barg.

17. The method of claim 1 wherein the reacting of methane and sulfur is conducted at a reactor temperature of from about 500° C. to about 800° C.

18. The method of claim 1 wherein the reacting of methane and sulfur is conducted at a reactor temperature of from about 600° C. to about 700° C.

19. The method of claim 1 wherein the reacting of the produced hydrogen disulfide with methane is conducted at a reactor pressure of from about 0.6 barg to about 4.0 barg.

20. The method of claim 1 wherein the reacting of the produced hydrogen disulfide with methane is conducted at a reactor pressure of from about 1.2 barg to about 2.8 barg.

21. The method of claim 1 wherein the reacting of the produced hydrogen disulfide with methane is conducted at a reactor temperature of from about 700° C. to about 1100° C.

22. The method of claim 1 wherein the reacting of the produced hydrogen disulfide with methane is conducted at a reactor temperature of from about 800° C. to about 1000° C.

23. The method of claim 1 which further comprises separating carbon disulfide and hydrogen in the mixture at a temperature of from about −50° C. to about −10° C. and a pressure of from about 0.9 barg to about 1.9 barg.

24. A system comprising:
a first reactor configured to react methane and sulfur under conditions sufficient to produce carbon disulfide, hydrogen disulfide, and heat in an exothermic reaction; and
a second reactor operatively coupled to the first reactor, wherein the second reactor is configured to react at least a portion of the produced hydrogen disulfide from the first reactor with methane under conditions sufficient to produce a mixture comprising carbon disulfide and hydrogen in an endothermic reaction;
wherein the first reactor and second reactor are heat integrated such that at least a portion of the heat generated in the exothermic reaction between methane and sulfur in the first reactor is employed to propagate the endothermic reaction between the produced hydrogen disulfide and methane in the second reactor.
